(19) United States
(12) Patent Application Publication
(10) Pub. No.: US 2011/0131815 A1
(43) Pub. Date: Jun. 9, 2011

(54) COMBINATION BLOWER AND TRIMMER ASSEMBLY

(76) Inventor: Edward P. Hurley, Sarasota, FL (US)

(21) Appl. No.: 12/632,958

(22) Filed: Dec. 8, 2009

(51) Int. Cl. A01D 34/416; A01D 42/00

(52) U.S. Cl. 30/276; 15/339

(57) ABSTRACT

A combination blower and trimmer assembly including a centrifugal clutch transmission for shifting a drive shaft driven by a motor between engagement with an impeller of the blower and engagement with a drive shaft of the trimmer for selective operation of either the blower or trimmer.

### FIELD OF THE INVENTION

The present invention relates generally to lawn care equipment, and more particularly, relating to a combination blower and trimmer assembly for using in cutting vegetation and clearing areas from debris where the blower and trimmer portions are independently and separately operable.

### BACKGROUND OF THE INVENTION

Complete lawn care now typically includes trimming areas that lawn mowers cannot access easily; edging vegetation along defined perimeters, such as curbs; and removing the vegetation debris, such as lawn trimmings or fallen leaves, from areas where they are not wanted, such as sidewalks and driveways, typically by blowing them away to an area where they will not be seen, such as the lawn. Carrying out these separate tasks has traditionally required different and separate tools, namely, a lawn mower, a string trimmer, an edger and a blower.

In commercial applications particularly, such as grooming golf courses, the necessity for using different and separate tools for these tasks leads to lost time and inefficiency because workers must return to a tool shed or truck, often located at some distance from the workers, to retrieve the appropriate tool. A worker may carry and use a particular tool, for example, a string trimmer, for several hours without pause, leading him far from his tool shed or truck. The worker cannot carry all these different tools with him due to their bulk and weight.

Combining the functionality of some of these separate tools into a single tool would save time and money, including capital outlay for the tools.

Some efforts in that direction have been taken. For example, a device includes separate operating heads, such as a string trimmer head or a blower head, that can be attached and detached from the same power plant and drive train, saving the expense of a second motor. This system still requires that a significant subassembly of the tool be removed and replaced by another tool, requiring the worker to carry separate tools and to change operating heads on the tool. This system has the same disadvantages as having separate tools when they are used.

Another device includes a blower chute that can be strapped onto the bottom of a string trimmer with a bungee cord, but does not allow the string trimmer function to be used when the blower attachment is installed, requiring the operator to carry separate subsystems and install and remove them to carry out the separate functions of trimming and blowing.

Another device discloses a string trimmer with a specially designed shroud that is supposed to help the rotating string of the string trimmer to function as a blower. While it has long been known that the rotating string of the string trimmer provides some blowing forces, they tend to be non-directional and basically downward and outward from the rotating string, which provides little benefit in debris removal from sidewalks and so forth. Further, any blowing force generated by the rotating string is minimal and will not move debris any significant distance.

Another device discloses a string trimmer that can be converted to a blade trimmer and that can be modified to attach a blower flute or scroll to direct air flow generated by a cooling fin that is part of the string trimmer spool and designed to cool the motor of the apparatus. The use of this fan in a attempt to create a blower function is inadequate because it utilizes a fan that is designed only for motor cooling and is structurally a part of a string trimmer head, limiting its utility for actually blowing debris, due to its position and its use to cool the motor. A string trimmer head that does not include a cooling fan could apparently not be used with this device.

Another device discloses a string trimmer and blower combination that includes a separate blower assembly and trimmer assembly. The blower assembly includes an air inlet and an air inlet cover that is positionable to close the air inlet, and thus prevent the blower from discharging an appreciable air flow. The idea is to close the air inlet when it is not desirable to use the blower function to starve the blower impeller of intake air. The trimmer head can be removed when it is desirable to use the blower. Closing off the air inlet to the blower while the blower impeller is driven is not desirable as it would result in heat build-up and likely failure of the blower. Further, this device requires the engine or motor to be turned off to switch between blower and trimmer usage.

Therefore, there remains a need for an improved yard tool that combines both aspects of blowing debris and trimming vegetation that does not require disassembly of the yard tool to switch between blowing and trimming, that does not require the attachment of accessories to convert between blowing and trimming, that does not result in over heating, and that does not require the motor of the yard tool to be stopped to convert between blowing and trimming, among others benefits and advantages.

### SUMMARY OF THE INVENTION

The preferred embodiments of the present invention addresses this need by providing a yard tool having a combination blower and trimmer assembly including a blower and a trimmer head that are independently and separately operable.

To achieve this and other advantages, in general, in one aspect, a combined blower and line trimmer assembly for use in connection with a yard tool having an elongated boom, and a drive shaft operatively connected to a motor for rotating the drive shaft is provided. The combined blower and line trimmer assembly includes a blower housing connected to the elongated boom of the yard tool. The blower housing has an interior cavity, an air inlet to said interior cavity, and an air outlet to said interior cavity. An impeller is disposed for rotation about an axis of rotation within said interior cavity to draw air into said interior cavity through said air inlet and to discharge air through said air outlet when said impeller is caused to rotate. Opposed upper and lower clutch bells are disconnected and separately rotatable. The upper clutch bell is connected to said impeller and fixed therewith for conjoined rotation. The lower clutch bell has an output shaft connected therewith for conjoined rotation. A string trimmer head is removably attached to said output shaft for conjoined rotation. A clutch having one or more centrifugal operated clutch shoes is operatively connected to the drive shaft for conjoined rotation therewith. The clutch is alternately positionable between within said upper clutch bell and within said lower clutch bell. When said clutch is disposed within said upper clutch bell said clutch shoes are operable to engage said clutch and said upper clutch bell together to operatively engage the drive shaft with said impeller to axially rotate said impeller about the axis of rotation. When said clutch is disposed within said lower clutch bell said clutch shoes are operable to engage said clutch and said lower clutch bell together to operatively engage the drive shaft with said output shaft to rotate said output shaft and said string trimmer head connected to said output shaft about the axis of rotation, whereby said impeller and said line trimmer assembly connected to said output shaft are independently and alternately operable.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a perspective view of a yard tool comprising the combination blower and trimmer assembly constructed in accordance with the principles of the invention;

FIG. 2 is a top plan view of the combination blower and trimmer assembly;

FIG. 3 is a side elevation view of the combination blower and trimmer assembly;

FIG. 4 is a perspective bottom view of an upper housing of a blower housing of the combination blower and trimmer assembly; and

FIG. 5 is a side cross-sectional view of the combination blower and trimmer assembly.

### DETAILED DESCRIPTION OF THE INVENTION

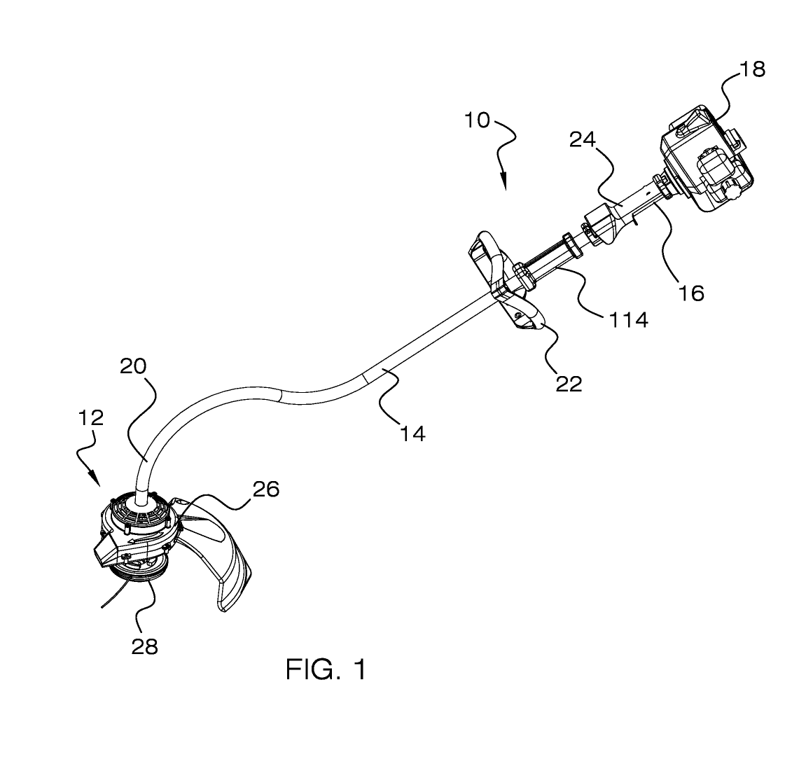

Referring now to the drawings, in FIG. 1, there is shown a yard tool 10 having a combination blower and trimmer assembly 12 of the invention having a blower 26 and a trimmer head 28. The yard tool 10 includes a drive shaft housing or elongated boom 14 having an upper end 16 supporting a motor 18 and a lower end 20 supporting the combination blower and trimmer assembly 12. While motor 18 is illustrated as an internal combustion engine, alternatively, the motor could be an electrical motor. A drive shaft disposed within the boom 14 is operatively connected to the motor 18 at one end and at the opposite end the drive shaft is operatively connected to the combination blower trimmer assembly 12 to either drive the blower 26 or the trimmer head 28. Handles 22 and 24 attached to boom 14 permit a user to grasp and operate the yard tool 10 in a conventional manner. In alternative embodiments, boom 14 may include different configurations, such as a “straight shaft” configuration, as opposed to a “curved shaft” configuration as illustrated. It is important to note, while boom 14, motor 18, and handles 22 and 24 are necessary to complete the assembly of the yard tool 10 and to operate the yard tool, their respective and particular constructions are not essential to the construction and operation of the combination blower and trimmer assembly 12. It is contemplated, in embodiments of the combination blower and trimmer assembly 12 the assembly may be attached to an existing yard tool in an aftermarket or retrofit application.

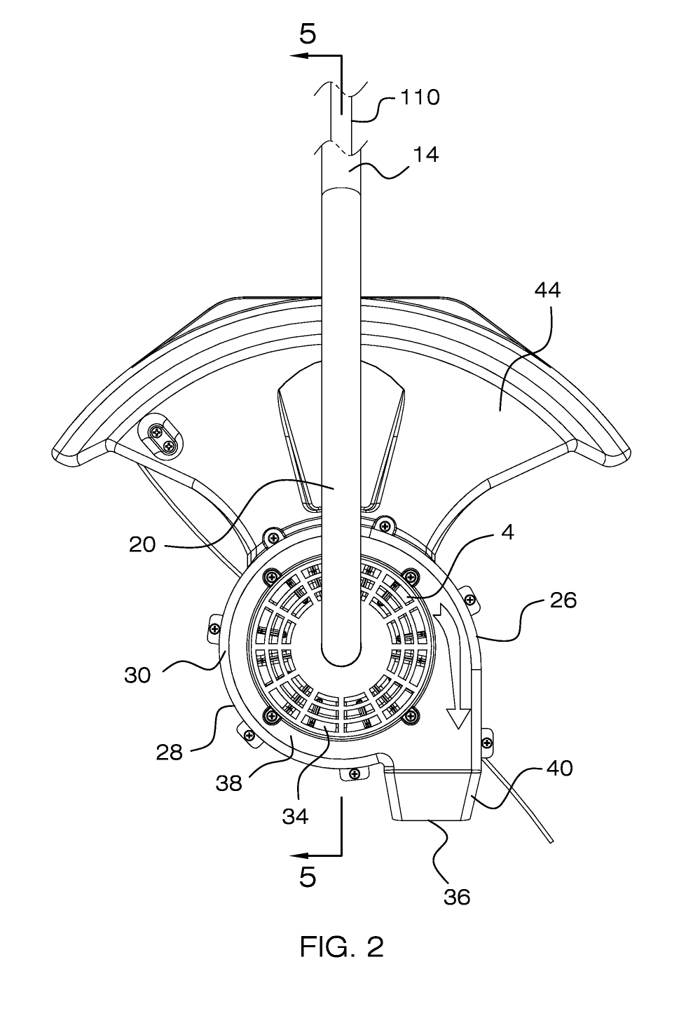

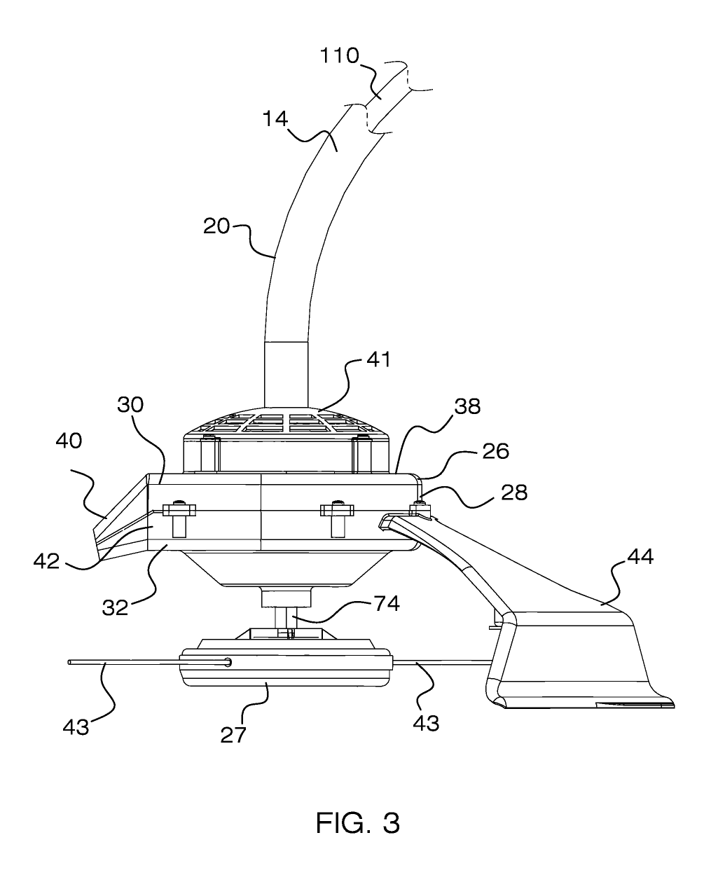

Referring now to FIGS. 2 and 3, the combination blower and trimmer assembly 12 includes a blower 26 and trimmer head 28. As will be discussed in more detail below, blower 26 and trimmer head 28 are independently and alternately engaged with the drive shaft for operation. In other words, when the drive shaft is engaged with blower 26 for driving the same, the drive shaft is not engaged with the trimmer head 28. Likewise, when the drive shaft is engaged with the trimmer head 28 for driving the same, the drive shaft is not engaged with the blower 26.

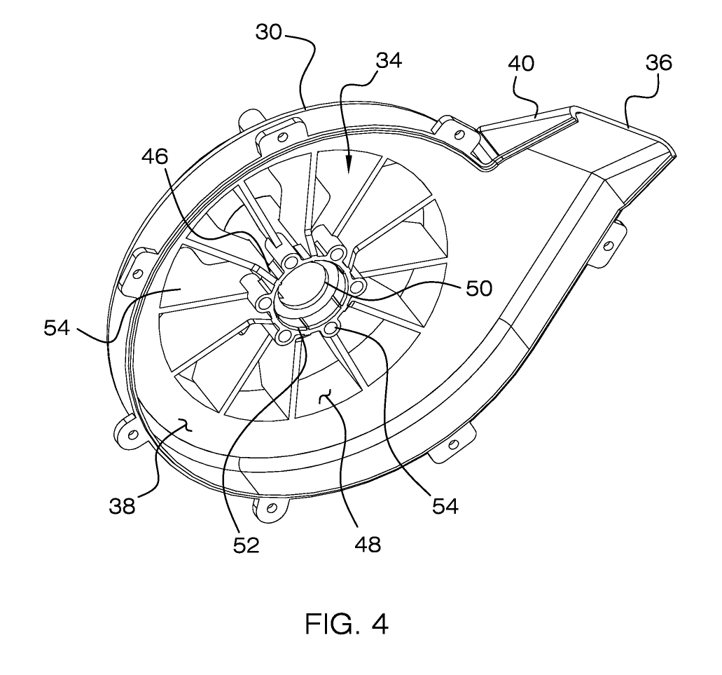

Blower 26 includes blower housing 28 having an upper housing 30 and a lower housing 32 mated together by a plurality of cooperating holes and fasteners positioned about the periphery thereof, respectively. The upper housing 30 and lower housing 32 together form an interior cavity in which an impeller is rotatably disposed. The blower housing 28 further includes an air inlet 34 (best shown in FIG. 4) to the interior cavity and an air outlet 36 to the interior cavity. Air inlet 34 extends through an upper surface 38 of the blower housing 28, thereby lessening the chance of debris from being drawn into the blower 26 during operation. Air outlet 36 includes nozzle 40 extending from a side surface 42 of the blower housing 28. As will be further described in detail below, the impeller disposed within the interior cavity of the blower housing 28 is driven to draw air into the interior cavity through air inlet 34 and to discharge the drawn air through air outlet 36. Air inlet 34 can be covered by a vented air inlet covering 41 to further prevent debris from being drawn into the blower 26 during operation. Air inlet cover 41 is attached to the upper housing 30 over air inlet 34 by a plurality of cooperating holes and fasteners positioned about the periphery thereof. Alternatively, air inlet cover 41 and upper housing 30 may be one integrated piece, as opposed to two or more pieces connected together as shown.

With continued reference to FIG. 3, with blower 26 disposed generally horizontally, air nozzle 40 is generally angled downwardly to direct discharge air at a ground surface without requiring an operator to tilt the blower out of the horizontal plane. Nozzle 40 is disposed on blower housing 28 at a side opposite of an operator to direct debris away from the operator in a direction generally along the traveling path of the operator.

Still referring to FIGS. 2 and 3, as illustrated with the assembly 12 disposed generally horizontally, the trimmer head 28 is disposed vertically below blower 26. Trimmer head 28 can include fixed rigid blades, pivotal rigid blades, flexible string blades 43 as shown, or any other suitable vegetation cutting blade. Trimmer head 28 is connected to trimmer head drive shaft 74 that is driven to rotate the trimmer head to cut vegetation, as will be further described below. An optional trimmer shield 44 can be provided to shield an operator from contact with the blades 42. Trimmer shield 44 is an accessory and is not required in the operation of the invention. The trimmer shield 44 is attached to the blower housing 28 on a side opposite of the air outlet 36. The blower housing 28 and the trimmer shield 44 may be one integrated piece or the may consist of two or more separate pieces connected together.

FIG. 4 is a bottom perspective view of the upper housing 30 of the blower housing 28. This view better illustrates air inlet 34 through upper surface 38. A hub 46 is centrally disposed within air inlet 34 and a plurality of slender fins 54 radially extend between air inlet wall 48 and hub 46. Hub 46 includes a through bore 50 through which a clutch drive shaft extends for connection to the drive shaft connected to motor 18, as will further be described below. Hub 46 further includes an impeller bearing recess 52 for the reception of a an impeller bearing assembly used to rotatably support the impeller within in the internal cavity of the blower housing. A plurality of fastener reception bores 54 are spaced circumferentially around impeller bearing recess 52 for attaching a impeller bearing cap (not shown) to retain the impeller bearing assembly within the impeller bearing recess and to retain and engage the impeller hub of the impeller with the impeller bearing assembly. Further as can be seen, the upper housing 30 forms an upper portion of air outlet 36 and nozzle 40.

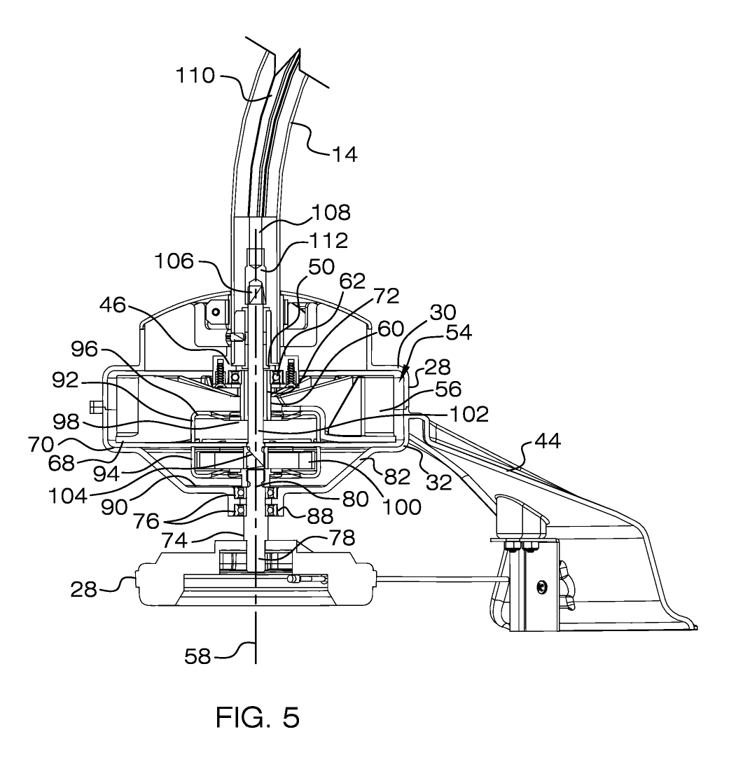

Referring now to FIG. 5, there is shown a side cross sectional view of assembly 12. As discussed above, upper housing 30 and lower housing 32 of the blower housing 28 together define an internal cavity 54. Impeller 56 is disposed within the internal cavity 54 for rotation about an axis of rotation 58. Impeller hub 60 is rotatably engaged with impeller bearing assembly 62, thereby supporting the impeller 56 for rotation within internal cavity 54 with a bottom surface 68 of the impeller slightly spaced from a shoulder portion 70 of the bottom housing 32. Impeller 56 further includes a through bore 72 that is coaxially aligned with bore 50 of hub 46 from which the impeller suspends. Bores 50 and 72 are coaxial with axis of rotation 58.

Still referring to FIG. 5, trimmer head drive shaft 74 is retained for rotation about axis of rotation 58 by trimmer head bearing assembly 76. The trimmer head bearing assembly 76 is pressed into bore 88 coaxially aligned with axis 58 and disposed through a lower surface 90 of the lower housing 32. Trimmer head bearing assembly 76 retains trimmer head drive shaft 74 from axial translation and rotatably connects the trimmer head drive shaft to lower housing 32. Trimmer head 28 is connected to the outward end 78 of the trimmer head drive shaft 74, while the inward end 80 of the trimmer head drive shaft partially extends into a frusto-conical shaped portion 82 of the internal cavity 54. The frusto-conical shaped portion 82 is defined by the lower housing 32 of the blower housing 28.

An upper clutch bell or impeller clutch bell 92 and a lower clutch bell or trimmer head clutch bell 94 are attached in an opposed and facing relationship to the impeller 56 and inward end 80 of the trimmer head drive shaft 74, respectively. Impeller clutch bell 92 is positioned within impeller clutch bell recess 96 centrally located on the bottom of the impeller 56. Impeller clutch bell 92 is fixedly attached to the impeller 56 for conjoined rotation therewith. Impeller clutch bell 92 includes an opening 98 coaxially aligned with axis 58 and bore 72 of the impeller hub 60. Trimmer head clutch bell 94 is fixedly attached to trimmer head drive shaft 74 for conjoined rotation therewith.

A centrifugal clutch 100 is disposed for reciprocation along axis 58 between impeller clutch bell 92 and trimmer head clutch bell 94. As shown, centrifugal clutch 100 is positioned within trimmer head clutch bell 94. Clutch drive shaft 102 is fixedly attached at end 104 to clutch 100, and extends upwardly therefrom along axis 58 freely through opening 98 of impeller clutch 92, bore 72 of impeller hub 60, and bore 50 of upper housing hub 46. In other words, opening 98, bore 72, and bore 50 each have an internal diameter greater than the diameter of the clutch drive shaft 102 such that clutch drive shaft is free from engagement with the same, respectively. The opposite end 106 of the clutch drive shaft 102 is connected to end 108 of drive shaft 110 by shaft coupling 112. To this end, clutch drive shaft 102 is driven by drive shaft 110 connected to motor 18 for rotation about axis 58. The operation of centrifugal clutches is well known in the art, therefore a full discussion of such operation is not required here. However, briefly, when the clutch 100 reaches a certain RMP, the clutch activates to engage either the impeller clutch bell 92 or the trimmer head clutch bell 94 to engage the same to drive shaft 110, thereby driving the impeller or trimmer head, respectively. When RMP of the clutch 100 drops below the engagement RMP the clutch disengages the respective clutch bell. It is important to note, clutch 100 will not operate to engage while motor 18 is at idle speed, thereby permitting the clutch to be shifted between the impeller clutch bell 92 and the trimmer head clutch bell 94.

Lever or actuator 114 (FIG. 1) is operated to position clutch 100 to be engaged with impeller clutch bell 92 or trimmer head clutch bell 94 by reciprocating clutch drive shaft 110 along axis 58 to be positioned within impeller clutch bell or trimmer head clutch bell, respectively. Actuator 114 can be coupled to clutch drive shaft 102 directly, or alternatively, the actuator can be coupled to drive shaft 110 to reciprocate drive shaft 110 along axis 58, and thus through its connection to clutch drive shaft 102, the clutch drive shaft and clutch are thus positioned accordingly. In one embodiment, actuator 114 operates to extend or retract the longitudinal length of drive shaft 110. By extending the length of drive shaft 110, clutch 100 is positioned within trimmer head clutch bell 94 for engagement therewith to drive the trimmer head 28. By shortening the length of drive shaft 110, clutch 100 is positioned within impeller clutch bell 92 for engagement therewith to drive the impeller 56. Spring stops (not shown) or the like can be incorporated in any suitable location along the drive train or actuator 114 to prevent over shifting of the clutch 100 to far of a distance in either direction.

In operation, it can now be understood, a user starts the motor 18 in a conventional manner, and while the motor is at idle speed, the user operates the actuator 114 to select either the blower 26 or the line trimmer 28 for operation, as described above. Once the selection is made, the user manipulates the motor throttle to raise the motor rpm and thus cause the clutch 100 to engage either the impeller clutch bell 92 or the trimmer head clutch bell 94 to drive the same according to the user's selection made by the actuator 114.

For example, should the user desire to trim vegetation, motor 18 is allowed to be brought to idle speed, then the user operates actuator 114 to select the trimming mode. By selecting the trimming mode, the actuator 114 is operated to shift clutch 100 in position to be engaged with the trimmer head clutch bell 94. The user then operates the motor throttle to raise the motor speed to a sufficient rmp to cause the clutch 100 to engage the trimmer head clutch bell 94, thereby connecting motor drive shaft 110 to the trimmer head 28 to drive the same. When the user desires to operate blower 26, such as for example, to remove vegetation debris, the user releases the motor throttle allowing the motor speed to drop to idle speed. With the motor 18 at idle speed, the user is able to once again operate actuator 114 to select the blowing mode. By selecting the blowing mode, the actuator 114 is operated to shift clutch 100 in position to be engaged with the impeller clutch bell 92. The user then operates the motor throttle to raise the motor speed to a sufficient RMP to cause the clutch 100 to engage the impeller clutch bell 92, thereby connecting motor drive shaft 110 to the impeller 56 to drive the same. To this end, a user is not required to stop the motor 18 to select the desired operation mode and is not required to detach or attach the trimmer head to switch between trimming and blowing operating modes.

An added benefit of the invention, is the trimmer head 28 or the blower 26 are not operated during dwell periods while the motor is running. This has the added benefit during dwell periods of reducing heat in the assembly 12, reducing noise created by either the blower 26 or trimmer head 28, and protecting the user from injury caused by contact with the cutting blades of the trimmer head.

A number of embodiments of the present invention have been described. Nevertheless, it will be understood that various modifications may be made without departing from the spirit and scope of the invention. Accordingly, other embodiments are within the scope of the following claims.

1. (canceled)

2. The combined blower and line trimmer assembly of claim 11, wherein said clutch is translatable between said upper and said lower clutch bells axially along the axis of rotation.

3. The combined blower and line trimmer assembly of claim 11, further comprising:
a trimmer shield disposed on said blower housing.

4. The combined blower and line trimmer assembly of claim 11, wherein said air inlet is disposed on an upper surface of said blower housing.

5. The combined blower and line trimmer assembly of claim 11, wherein said air outlet is disposed on a side surface of said blower housing.

6. The combined blower and line trimmer assembly claim 11, wherein the drive shaft is translatable along the axis of rotation to position said clutch between within said upper clutch bell and within said lower clutch bell.

7. (canceled)

8. The combined blower and line trimmer assembly of claim 11, wherein said actuator is connected to the drive shaft.

9. The combined blower and line trimmer assembly of claim 8, wherein said actuator is disposed on the elongated boom.

10. The combined blower and line trimmer assembly of claim 11, wherein said upper clutch bell is supported for rotation by a first bearing assembly disposed at an upper surface of said blower housing, and wherein said lower clutch bell is supported for rotation by a second bearing assembly disposed at a lower surface of said blower housing.

11. A combined blower and line trimmer assembly for use in connection with a yard tool having an elongated boom, and a drive shaft operatively connected to a motor for rotating the drive shaft, the combined blower and line trimmer assembly comprising:
a blower housing connected to the elongated boom of the yard tool, said blower housing having an interior cavity, an air inlet to said interior cavity, and an air outlet to said interior cavity;
an impeller disposed for rotation about an axis of rotation within said interior cavity to draw air into said interior cavity through said air inlet and to discharge air through said air outlet when said impeller is caused to rotate;
opposed upper and lower clutch bells, wherein said upper and lower clutch bells are disconnected and separately rotatable;
said upper clutch bell connected to said impeller and fixed therewith for conjoined rotation;
said lower clutch bell having an output shaft connected therewith for conjoined rotation;
a string trimmer head removably attachable to said output for conjoined rotation;
a centrifugal clutch operatively connected to the drive shaft for conjoined rotation therewith, said centrifugal clutch alternately positionable between within said upper clutch bell and within said lower clutch bell;
an actuator operatively connected to said clutch and operable to position said clutch between within said upper clutch bell and within said lower clutch bell;
wherein when said centrifugal clutch is disposed within said upper clutch bell said centrifugal clutch is operable to engage said upper clutch bell together to operatively engage the drive shaft with said impeller to axially rotate said impeller about the axis of rotation; and
wherein when said centrifugal clutch is disposed within said lower clutch bell said centrifugal clutch shoes is operable to engage said centrifugal clutch and said lower clutch bell together to operatively engage the drive shaft with said output shaft to rotate said output shaft and said string trimmer head connected to said output shaft about the axis of rotation, whereby said impeller and said line trimmer assembly connected to said output shaft are independently and alternately operable.
